(19) United States
(12) Patent Application Publication
(10) Pub. No.: US 2014/0017578 A1
(43) Pub. Date: Jan. 16, 2014

(54) Reducing Oxygen and Electrolyte Transport Limitations in the Lithium/Oxygen Battery through Electrode Design and Wetting Control

(71) Applicant: Robert Bosch GmbH, Stuttgart (DE)

(72) Inventors: Paul Albertus, Mountain View, CA (US); John F. Christensen, Mountain View, CA (US); Timm Lohmann, Mountain View, CA (US); Roel Sanchez-Carrera, Somerville, MA (US); Boris Kozinsky, Waban, MA (US); Christina Johnston, Palo Alto, CA (US)

(73) Assignee: Robert Bosch GmbH, Stuttgart (DE)

(21) Appl. No.: 13/939,303

(22) Filed: Jul. 11, 2013

Related U.S. Application Data
(60) Provisional application No. 61/670,461, filed on Jul. 11, 2012.

(51) Int. Cl. H01M 4/86

(52) U.S. Cl. CPC H01M 4/86
USPC 429/405; 429/535

(57) ABSTRACT

A battery system in one embodiment includes a negative electrode, a separator layer adjacent to the negative electrode, and a positive electrode adjacent to the separator layer, the positive electrode including a gas phase and an electrically conductive framework defining at least one wetting channel, the wetting channel configured to distribute an electrolyte within the electrically conductive framework.

This application claims the benefit of U.S. Provisional Application No. 61/670,461, filed on Jul. 11, 2012, the entire contents of which are herein incorporated by reference.

### TECHNICAL FIELD

This invention relates to batteries and more particularly to metal/oxygen based batteries.

### BACKGROUND

Rechargeable lithium-ion batteries are attractive energy storage systems for portable electronics and electric and hybrid-electric vehicles because of their high specific energy compared to other electrochemical energy storage devices. As discussed more fully below, a typical Li-ion cell contains a negative electrode, a positive electrode, and a separator region between the negative and positive electrodes. Both electrodes contain active materials that insert or react with lithium reversibly. In some cases the negative electrode may include lithium metal, which can be electrochemically dissolved and deposited reversibly. The separator contains an electrolyte with a lithium cation, and serves as a physical barrier between the electrodes such that none of the electrodes are electronically connected within the cell.

Typically, during charging, there is generation of electrons at the positive electrode and consumption of an equal amount of electrons at the negative electrode, and these electrons are transferred via an external circuit. In the ideal charging of the cell, these electrons are generated at the positive electrode because there is extraction via oxidation of lithium ions from the active material of the positive electrode, and the electrons are consumed at the negative electrode because there is reduction of lithium ions into the active material of the negative electrode. During discharging, the exact opposite reactions occur.

When high-specific-capacity negative electrodes such as a metal are used in a battery, the maximum benefit of the capacity increase over conventional systems is realized when a high-capacity positive electrode active material is also used. For example, conventional lithium-intercalating oxides (e.g., LiCoO₂, LiNi_{0.8}Co_{0.15}Al_{0.05}O₂, Li_{1.1}Ni_{0.3}Co_{0.3}Mn_{0.3}O₂) are typically limited to a theoretical capacity of ˜280 mAh/g (based on the mass of the lithiated oxide) and a practical capacity of 180 to 250 mAh/g, which is quite low compared to the specific capacity of lithium metal, 3863 mAh/g. The highest theoretical capacity achievable for a lithium-ion positive electrode is 1794 mAh/g (based on the mass of the lithiated material), for Li2O. Other high-capacity materials include BiF₃ (303 mAh/g, lithiated), FeF₃ (712 mAh/g, lithiated), and others. Unfortunately, all of these materials react with lithium at a lower voltage compared to conventional oxide positive electrodes, hence limiting the theoretical specific energy. Nonetheless, the theoretical specific energies are still very high (>800 Wh/kg, compared to a maximum of ˜500 Wh/kg for a cell with lithium negative and conventional oxide positive electrodes, which may enable an electric vehicle to approach a range of 300 miles or more on a single charge.

FIG. 1 depicts a chart 10 showing the range achievable for a vehicle using battery packs of different specific energies versus the weight of the battery pack. In the chart 10, the specific energies are for an entire cell, including cell packaging weight, assuming a 50% weight increase for forming a battery pack from a particular set of cells. The U.S. Department of Energy has established a weight limit of 200 kg for a battery pack that is located within a vehicle. Accordingly, only a battery pack with about 600 Wh/kg or more can achieve a range of 300 miles.

Various lithium-based chemistries have been investigated for use in various applications including in vehicles. FIG. 2 depicts a chart 20 which identifies the specific energy and energy density of various lithium-based chemistries. In the chart 20, only the weight of the active materials, current collectors, binders, separator, and other inert material of the battery cells are included. The packaging weight, such as tabs, the cell can, etc., are not included. As is evident from the chart 20, lithium/oxygen batteries, even allowing for packaging weight, are capable of providing a specific energy >600 Wh/kg and thus have the potential to enable driving ranges of electric vehicles of more than 300 miles without recharging, at a similar cost to typical lithium ion batteries. While lithium/oxygen cells have been demonstrated in controlled laboratory environments, a number of issues remain before full commercial introduction of a lithium/oxygen cell is viable as discussed further below.

A typical lithium/oxygen electrochemical cell 50 is depicted in FIG. 3. The cell 50 includes a negative electrode 52, a positive electrode 54, a porous separator 56, and a current collector 58. The negative electrode 52 is typically metallic lithium. The positive electrode 54 includes electrode particles such as particles 60 possibly coated in a catalyst material (such as Au or Pt) and suspended in a porous, electrically conductive matrix 62. An electrolyte solution 64 containing a salt such as LiPF₆ dissolved in an organic solvent such as dimethoxyethane or CH₃CN permeates both the porous separator 56 and the positive electrode 54. The LiPF₆ provides the electrolyte with an adequate conductivity which reduces the internal electrical resistance of the cell 50 to allow a high power.

A portion of the positive electrode 52 is enclosed by a barrier 66. The barrier 66 in FIG. 3 is configured to allow oxygen from an external source 68 to enter the positive electrode 54 while filtering undesired components such as contaminant gases and fluids. The wetting properties of the positive electrode 54 prevent the electrolyte 64 from leaking out of the positive electrode 54. Alternatively, the removal of contaminants from an external source of oxygen, and the retention of cell components such as volatile electrolyte, may be carried out separately from the individual cells. Oxygen from the external source 68 enters the positive electrode 54 through the barrier 66 while the cell 50 discharges and oxygen exits the positive electrode 54 through the barrier 66 as the cell 50 is charged. In operation, as the cell 50 discharges, oxygen and lithium ions are believed to combine to form a discharge product Li₂O₂ or Li₂O in accordance with the following relationship:

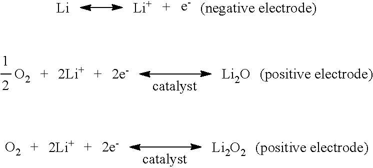

The positive electrode 54 in a typical cell 50 is a lightweight, electrically conductive material which has a porosity of greater than 80% to allow the formation and deposition/storage of Li₂O₂ in the cathode volume. The ability to deposit the Li₂O₂ directly determines the maximum capacity of the cell. In order to realize a battery system with a specific energy of 600 Wh/kg or greater, a plate with a thickness of 100 μm should have a capacity of 15 mAh/cm² or more.

Materials which provide the needed porosity include carbon black, graphite, carbon fibers, carbon nanotubes, and other non-carbon materials. There is evidence that each of these carbon structures undergoes an oxidation process during charging of the cell, due at least in part to the harsh environment in the cell (possibly pure oxygen, superoxide and peroxide ions and/or species, formation of solid lithium peroxide on the cathode surface, and electrochemical oxidation potentials of >3V (vs. Li/Li⁺)).

A number of investigations into the problems associated with Li-oxygen batteries have been conducted as reported, for example, by Beattie, S., D. Manolescu, and S. Blair, “High-Capacity Lithium—Air Cathodes,” Journal of the Electrochemical Society, 2009. 156: p. A44, Kumar, B., et al., “A Solid-State, Rechargeable, Long Cycle Life Lithium—Air Battery,” Journal of the Electrochemical Society, 2010. 157: p. A50, Read, J., “Characterization of the lithium/oxygen organic electrolyte battery,” Journal of the Electrochemical Society, 2002. 149: p. A1190, Read, J., et al., “Oxygen transport properties of organic electrolytes and performance of lithium/oxygen battery,” Journal of the Electrochemical Society, 2003. 150: p. A1351, Yang, X and Y. Xia, “The effect of oxygen pressures on the electrochemical profile of lithium/oxygen battery,” Journal of Solid State Electrochemistry: p. 1-6, and Ogasawara, T., et al., “Rechargeable Li₂O₂ Electrode for Lithium Batteries,” Journal of the American Chemical Society, 2006. 128(4): p. 1390-1393.

While some issues have been investigated, several challenges remain to be addressed for lithium-oxygen batteries. These challenges include limiting dendrite formation at the lithium metal surface, protecting the lithium metal (and possibly other materials) from moisture and other potentially harmful components of air (if the oxygen is obtained from the air), designing a system that achieves favorable specific energy and specific power levels, reducing the hysteresis between the charge and discharge voltages (which limits the round-trip energy efficiency), morphology changes in the metal upon extended cycling that result in a large overall volume change in the cell, changes in the structure and composition of the passivating layer that forms at the surface of the metal when exposed to certain electrolytes, which may isolate some metal and/or increase the resistance of the cell over time. Many of the foregoing are significant hurdles in improving the number of cycles over which the system can be cycled reversibly.

The limit of round trip efficiency occurs due to an apparent voltage hysteresis as depicted in FIG. 4. In FIG. 4, the discharge voltage 70 (approximately 2.5 to 3 V vs. Li/Li⁺) is much lower than the charge voltage 72 (approximately 4 to 4.5 V vs. Li/Li). The equilibrium voltage 74 (or open-circuit potential) of the lithium/oxygen system is approximately 3 V. Hence, the voltage hysteresis is not only large, but also very asymmetric.

The large over-potential during charge may be due to a number of causes. For example, reaction between the Li₂O₂ and the conducting matrix 62 may form an insulating film between the two materials. Additionally, there may be poor contact between the solid discharge products Li₂O₂ or Li₂O and the electronically conducting matrix 62 of the positive electrode 54. Poor contact may result from oxidation of the discharge product directly adjacent to the conducting matrix 62 during charge, leaving a gap between the solid discharge product and the matrix 52.

Also, complete disconnection of the solid discharge product from the conducting matrix 62 may result from fracturing, flaking, or movement of solid discharge product particles due to mechanical stresses that are generated during charge/discharge of the cell. Complete disconnection may contribute to the capacity decay observed for most lithium/oxygen cells. By way of example, FIG. 5 depicts the discharge capacity of a typical Li/oxygen cell over a period of charge/discharge cycles.

Other physical processes which cause voltage drops within an electrochemical cell, and thereby lower energy efficiency and power output, include mass-transfer limitations at high current densities. The transport properties of aqueous electrolytes are typically better than nonaqueous electrolytes, but in each case mass-transport effects can limit the thickness of the various regions within the cell, including the cathode. Reactions among O₂ and other metals besides lithium may also be carried out in various media.

What is needed therefore is a metal/oxygen battery that provides increased oxygen and electrolyte transport within the battery.

### SUMMARY

In one embodiment a battery system in one embodiment includes a negative electrode, a separator layer adjacent to the negative electrode, and a positive electrode adjacent to the separator layer, the positive electrode including a gas phase and an electrically conductive framework defining at least one wetting channel, the wetting channel configured to distribute an electrolyte within the electrically conductive framework.

In another embodiment, a method of forming a battery system includes providing a negative electrode, providing a separator layer adjacent to the negative electrode, forming at least one wetting channel within an electrically conductive framework, the wetting channel configured to distribute an electrolyte within the electrically conductive framework, forming a positive electrode adjacent to the separator layer with the electrically conductive framework, providing an electrolyte within the positive electrode, and providing a gas phase along with the electrolyte within the positive electrode.

In another embodiment, a positive electrode within a battery system includes an electrically conductive framework, an electrolyte, at least one wetting channel defined within the electrically conductive framework, the wetting channel configured to distribute the electrolyte within the electrically conductive framework, and a gas phase.

### BRIEF DESCRIPTION OF DRAWINGS

FIG. 1 depicts a plot showing the relationship between battery weight and vehicular range for various specific energies;

FIG. 2 depicts a chart of the specific energy and energy density of various lithium-based cells;

FIG. 3 depicts a prior art lithium-oxygen (Li/oxygen) cell including two electrodes, a separator, and an electrolyte;

FIG. 4 depicts a discharge and charge curve for a typical Li/oxygen electrochemical cell;

FIG. 5 depicts a plot showing decay of the discharge capacity for a typical Li/oxygen electrochemical cell over a number of cycles;

FIG. 6 depicts a schematic view of a lithium-oxygen (Li/oxygen) cell with two electrodes, one of which is configured to control the distribution of oxygen and electrolyte within the electrode, in a fully charged state;

FIG. 7 depicts a schematic view of the lithium-oxygen (Li/oxygen) cell of FIG. 6 in a partially discharged state; and

FIG. 8 depicts a schematic view of a lithium-oxygen (Li/oxygen) cell with two electrodes, one of which is configured to control the distribution of oxygen and electrolyte within the electrode, in a fully charged state using generally horizontally extending channels.

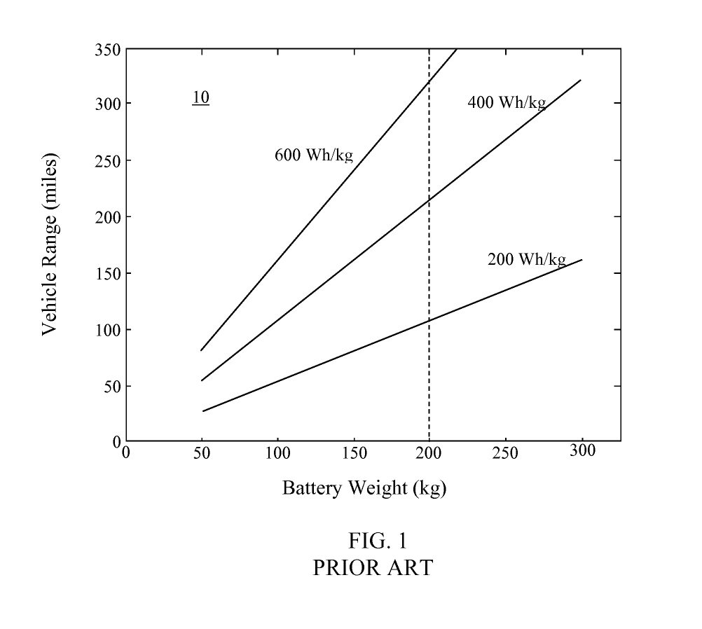

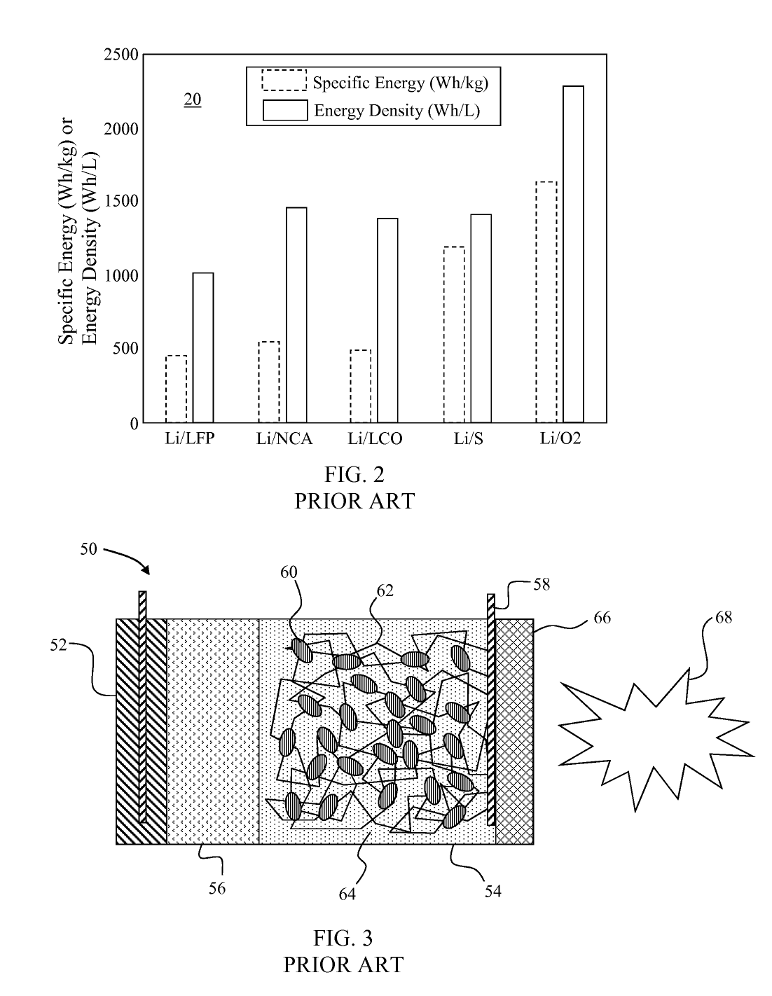

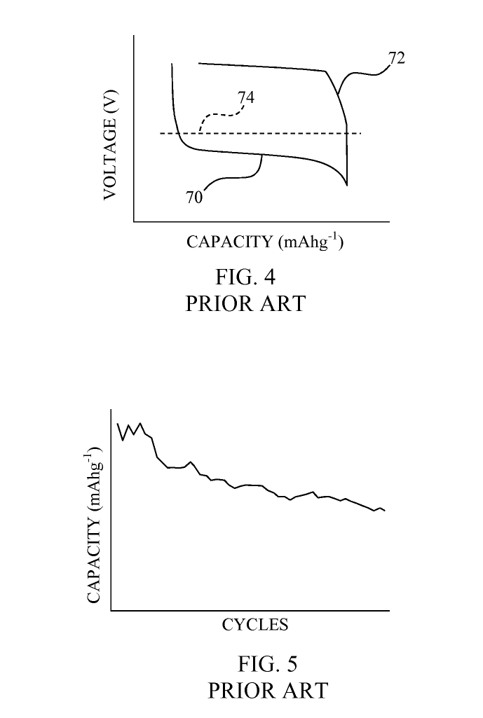

### DETAILED DESCRIPTION

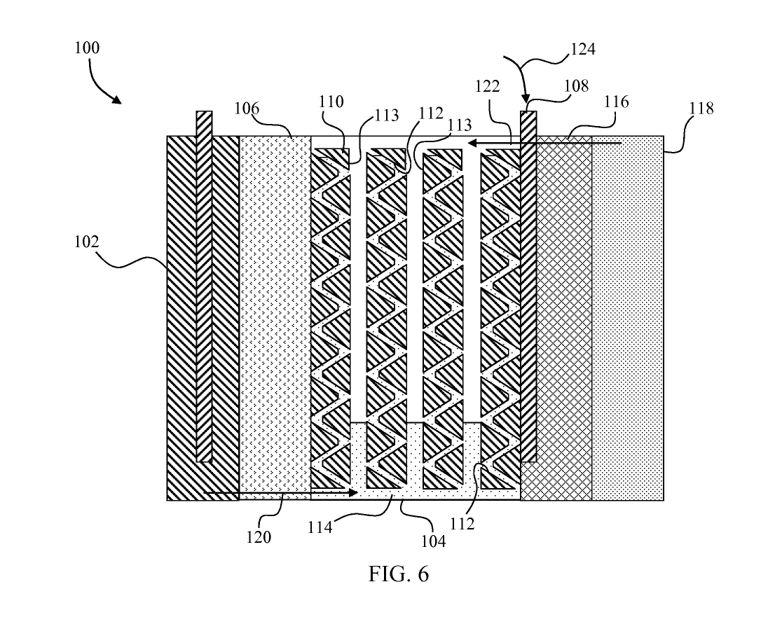

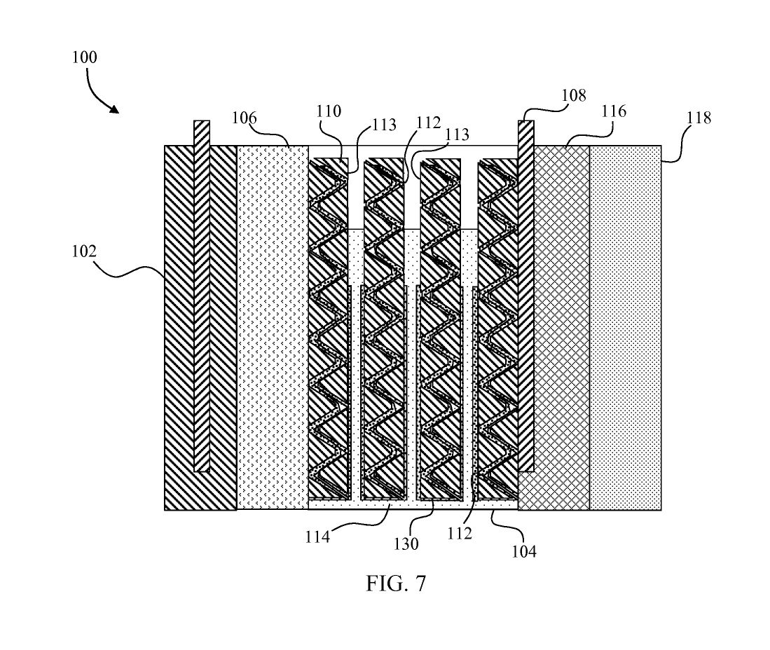

A schematic of an electrochemical cell 100 is shown in FIG. 6. The electrochemical cell 100 includes a negative electrode 102 separated from a positive electrode 104 by a porous separator 106. The negative electrode 102 may be formed from lithium metal or a lithium-insertion compound (e.g., graphite, silicon, tin, LiAl, LiMg, Li₄Ti₅O₁₂), although Li metal affords the highest specific energy on a cell level compared to other candidate negative electrodes. Other metals may also be used to form the negative electrode, such as Zn, Mg, Na, Fe, Al, Ca, Si, and others.

The positive electrode 104 in this embodiment includes a current collector 108 and an electrically conductive framework 110. The electrically conductive framework 110 is an electrically conductive matrix formed from a conductive material such as conductive carbon or a nickel foam, although various alternative matrix structures and materials may be used. The electrically conductive framework 110 defines wetting channels 112 and non-wetting channels 113. The separator 106 prevents the negative electrode 102 from electrically connecting with the positive electrode 104.

The electrochemical cell 100 includes an electrolyte solution 114 present in the positive electrode 104 and in some embodiments in the separator 106. In the exemplary embodiment of FIG. 6, the electrolyte solution 114 includes a salt, LiPF₆ (lithium hexafluorophosphate), dissolved in an organic solvent mixture. The organic solvent mixture may be any desired solvent. In certain embodiments, the solvent may be dimethoxyethane (DME), acetonitrile (MeCN), ethylene carbonate, or diethyl carbonate.

A barrier 116 separates the positive electrode 104 from a reservoir 118. The reservoir 118 may be any vessel suitable to hold oxygen supplied to and emitted by the positive electrode 104 or even the atmosphere. While the reservoir 118 is shown as an integral member of the electrochemical cell 100 attached to the positive electrode 104, in one embodiment the reservoir 118 is the positive electrode 104 itself. Various embodiments of the reservoir 118 are envisioned, including rigid tanks, inflatable bladders, and the like. In FIG. 6, the barrier 116 is a mesh which permits oxygen and other gases to flow between the positive electrode 104 and the reservoir 118 while also preventing the electrolyte 114 from leaving the positive electrode 104. Alternatively, the retention of cell components such as volatile electrolyte may be carried out separately from the individual cells, such that the barrier 116 is not required.

In the case in which the metal is Li, the electrochemical cell 100 discharges with lithium metal in the negative electrode 102 ionizing into a Li⁺ ion with a free electron e⁻. Li⁺ ions travel through the separator 106 in the direction indicated by arrow 120 toward the positive electrode 104. The Li⁺ ions travel within the wetting channels 112 and are dispersed throughout the electrically conductive framework 110.

The wetting channels 112 are configured to achieve uniform wetting of the electrically conductive framework 110 with the electrolyte 106. In one embodiment, the surfaces of the electronically conductive framework 110 are provided with a surface treatment to provide the desired wetting. Mixtures of materials with different surface treatments, more wetting and less wetting, are included as desired to encourage the segregation of electrolyte into the wetting channels 112. In one embodiment, all or part of the electronically conductive framework 110 is subjected to heat treatment in reductive gas. In other embodiments, fluorination, and/or silanation is used. Silanation with organosilanes (Rₙ—Si(OR′)₄₋ₙ) allows for a wide range of surface chemistries to be realized for this purpose.

In some embodiments including a non-aqueous electrolyte 114, non-polar surfaces are incorporated. An example of a suitable material is graphene, which is both electronically conductive and very nonpolar.

While the embodiment of FIG. 6 shows a uniform pattern of wetting channels 112, in some embodiments the pattern and/or the surface treatment of the electronically conductive framework 110 is varied. Such variation is used in applications wherein certain portions of the electrode 104 tend to flood, and in embodiments wherein certain portions of the electrode 104 tend to exhibit excessive drying.

The electronically conductive framework 110 further includes non-wetting channels 113. In some embodiments, non-wetting channels 113 are not included. The non-wetting channels 113 serve as oxygen gas channels throughout the electrode 104.

While hydrophobic materials are beneficial for the wetting of embodiments incorporating non-aqueous electrolytes, the use of hydrophilic materials, including those achieved through surface treatments that introduce polar groups (e.g., hydroxyl groups), facilitates the creation of non-wetting channels and regions 113 for oxygen gas flow.

Accordingly, oxygen is supplied from the reservoir 118 through the barrier 116 as indicated by the arrow 122. Therefore, free electrons e flow into the positive electrode 104 through the current collector 108 as indicated by arrow 124.

The oxygen atoms and Li⁺ ions within the positive electrode 102 form a discharge product 130 inside the positive electrode 104 (see FIG. 7). As seen in the following equations, during the discharge process metallic lithium is ionized, combining with oxygen and free electrons to form Li₂O₂ or Li₂O discharge product that may coat the surfaces of the electrically conductive framework 110.

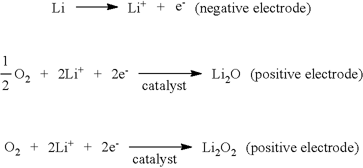

In accordance with the foregoing embodiment, the amount and distribution of non-aqueous electrolyte and oxygen gas in the cathode is carefully controlled such that transport limitations are minimized. The cell 100 thus provides increased power density, increased energy density, a higher round-trip energy efficiency at a given power or current density. The cell 100 also exhibits increased ability to provide electrolyte throughout the electrode 104 even as Li₂O₂ is deposited on the electrically conductive framework 110.

In general, the cell 100 is optimally configured such that in a fully charged state, the electrically conductive framework 110 occupies about 10% by volume of the electrode 104. The electrolyte 106 occupies about 25% by volume of the electrode 104. The gas phase of the oxygen occupies about 65% by volume of the electrode 104. This configuration provides uniform wetting of electrolyte 106 throughout the electrode 104 and uniform distribution of gas volume fraction within the electrode 104.

Upon fully discharging the cell 100, the electrically conductive framework 110 occupies about 10% by volume of the electrode 104. The electrolyte 106 occupies about 25% by volume of the electrode 104. The Li₂O₂ 130 occupies about 55% by volume of the electrode 104. The gas phase of the oxygen occupies about 10% by volume of the electrode 104.

The cell 100 thus provides optimization of the volume fractions and distribution of components by engineering the wetting of the electrolyte 106 on the surfaces of the electrically conductive framework 110. The configuration of the cell 100 ensures good access of the oxygen gas phase throughout the cathode by ensuring a pore structure and product structure that includes gas channels or an otherwise open pore structure.

In addition to or as an alternative to the above described use of wetting materials, gas transport through the electrode 104 in some embodiments is accomplished using reduced tortuosity of aligned electrode structures. In the embodiment of FIG. 6, the non-wetting channels 113 are non-tortuous while the wetting channels 112 are tortuous. In one embodiment, aligned carbon nanotubes are used. In one embodiment, long fibers are used to encourage porosity and reduce overall tortuosity while smaller electrode particles with higher surface area are incorporated to provide gas transport without sacrificing active surface area.

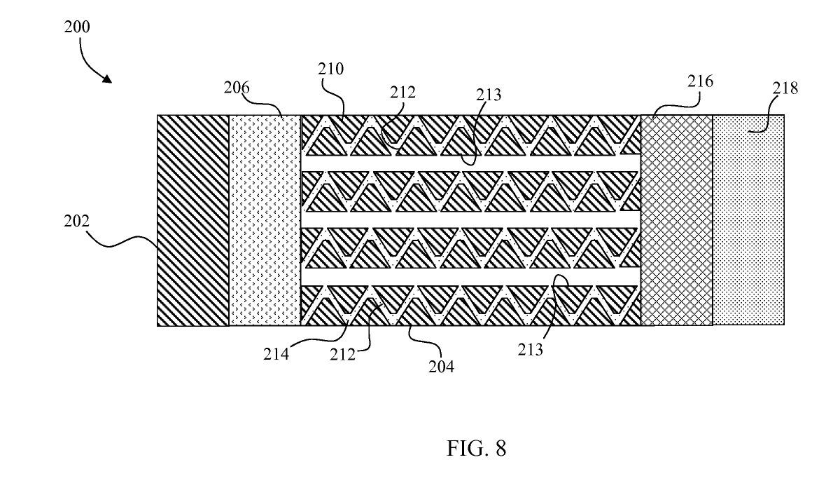

Moreover, while the non-wetting channels 113 and the wetting channels 112 are depicted as generally vertical, the actual orientation of the channels will vary depending upon the particular embodiment. Accordingly, FIG. 8 depicts an electrochemical cell 200 including a negative electrode 202 separated from a positive electrode 204 by a porous separator 206. The positive electrode 204 in this embodiment includes an electrically conductive framework 210. The electrically conductive framework 210 defines wetting channels 212 and non-wetting channels 213.

The electrochemical cell 200 includes an electrolyte solution 214 present in the positive electrode 204 and in some embodiments in the separator 206. A barrier 216 separates the positive electrode 204 from a reservoir 218.

The electrochemical cell 200 is thus substantially the same as the electrochemical cell 100. One difference is that the wetting channels 212 and non-wetting channels 213 extend generally horizontally. In other embodiments, a mixture of horizontally and vertically extending channels are used. In other embodiments, randomly oriented channels are used or intermixed with horizontally or vertically extending channels.

In some embodiments, low boiling solvents or high temperatures are used during electrode formation to induce a “mudcracking” effect of channels throughout the electrode. Gas transport is thus improved by the intentional introduction of defects in the electrode structure.

In addition to the above described configurations, some embodiments include gas-driven convection to provide both electrolyte and gas mixing. The oxygen gas, which in some embodiments includes inactive components from air, is used to mix the electrolyte and gas volumes within the cathode to provide a desired uniform distribution of oxygen gas and electrolyte.

While the invention has been illustrated and described in detail in the drawings and foregoing description, the same should be considered as illustrative and not restrictive in character. Only the preferred embodiments have been presented and all changes, modifications and further applications that come within the spirit of the invention are desired to be protected.

1. A battery system comprising:
a negative electrode;
a separator layer adjacent to the negative electrode; and
a positive electrode adjacent to the separator layer, the positive electrode including a gas phase and an electrically conductive framework defining at least one wetting channel, the wetting channel configured to distribute an electrolyte within the electrically conductive framework.

2. The battery system of claim 1, wherein the positive electrode is configured such that in a fully charged state:
the electrically conductive framework occupies about 10% by volume of the positive electrode;
the electrolyte occupies about 25% by volume of the positive electrode; and
the gas phase occupies about 65% by volume of the positive electrode.

3. The battery system of claim 2, wherein:
the gas phase comprises an oxygen gas phase; and
the negative electrode comprises a form of metal as an active component.

4. The battery system of claim 3, wherein the positive electrode is configured such that in a fully discharged state:
the electrically conductive framework occupies about 10% by volume of the positive electrode;
the electrolyte occupies about 25% by volume of the positive electrode;
the gas phase occupies about 10% by volume of the positive electrode; and
a discharge product occupies about 55% by volume of the positive electrode.

5. The battery system of claim 4, wherein:
the electrolyte is a non-aqueous electrolyte; and
the at least one wetting channel is defined at least in part by a hydrophobic material.

6. The battery system of claim 4, further comprising:
at least one non-wetting channel within the positive electrode, the at least one non-wetting channel configured such that when the at least one wetting channel is substantially filled with electrolyte, the at least one non-wetting channel is predominantly filled by the gas phase.

7. The battery system of claim 6, wherein the at least one non-wetting channel is defined at least in part by a hydrophilic material.

8. The battery system of claim 6, wherein:
the at least one non-wetting channel has a first nominal width;
the at least one wetting channel has a second nominal width; and
the first nominal width is greater than the second nominal width.

9. The battery system of claim 6, wherein:
the at least one non-wetting channel has a first tortuosity;
the at least one wetting channel has a second tortuosity; and
the first tortuosity is less than the second tortuosity.

10. The battery system of claim 6, wherein:
the at least one wetting channel comprises a plurality of wetting channels; and
the plurality of wetting channels form a uniform pattern within the electrically conductive framework.

11. A method of forming a battery system comprising:
providing a negative electrode;
providing a separator layer adjacent to the negative electrode;
forming at least one wetting channel within an electrically conductive framework, the wetting channel configured to distribute an electrolyte within the electrically conductive framework;
forming a positive electrode adjacent to the separator layer with the electrically conductive framework;
providing an electrolyte within the positive electrode; and
providing a gas phase along with the electrolyte within the positive electrode.

12. The method of claim 11, wherein forming the positive electrode comprises:
filling about 10% by volume of the positive electrode with the electrically conductive framework;
filling no more than about 25% by volume of the positive electrode with the electrolyte; and
filling about 65% by volume of the positive electrode with the gas phase.

13. The method of claim 12, wherein:
providing the electrolyte comprises providing a non-aqueous electrolyte; and
forming at least one wetting channel comprises forming the at least one wetting channel with a hydrophobic material.

14. The method of claim 12, wherein:
forming at least one wetting channel comprises heat treating the electrically conductive framework in a reductive gas environment.

15. The method of claim 12, further comprising:
forming at least one non-wetting channel within the positive electrode, the at least one non-wetting channel configured such that when the at least one wetting channel is substantially filled with electrolyte, the at least one non-wetting channel is predominantly filled by the gas phase.

16. The method of claim 15, wherein forming the at least one non-wetting channel comprises:
forming the at least one non-wetting channel with a hydrophilic material.

17. A positive electrode within a battery system, comprising:
an electrically conductive framework;
an electrolyte;
at least one wetting channel defined within the electrically conductive framework, the wetting channel configured to distribute the electrolyte within the electrically conductive framework; and
a gas phase.

18. The positive electrode of claim 17, wherein the positive electrode is configured such that in a fully charged state:
the electrically conductive framework occupies about 10% by volume of the positive electrode;
the electrolyte occupies about 25% by volume of the positive electrode; and
the gas phase occupies about 65% by volume of the positive electrode.

19. The positive electrode of claim 17, wherein the electrically conductive framework comprises a plurality of nanotubes.

20. The positive electrode of claim 17, further comprising:
at least one non-wetting channel, the at least one non-wetting channel configured such that when the at least one wetting channel is substantially filled with electrolyte, the at least one non-wetting channel is predominantly filled by the gas phase.
